(19) United States
(12) Patent Application Publication
(10) Pub. No.: US 2020/0344027 A1
(43) Pub. Date: Oct. 29, 2020

(54) NETWORK ACCESS NODE, CLIENT DEVICE AND METHODS FOR INITIAL ACCESS IN NEW RADIO

(71) Applicant: HUAWEI TECHNOLOGIES CO., LTD., Shenzhen (CN)

(72) Inventors: Bengt Lindoff, Kista (SE); Wenquan Hu, Lund (SE)

(21) Appl. No.: 16/924,210

(22) Filed: Jul. 9, 2020

Related U.S. Application Data
(63) Continuation of application No. PCT/EP2018/050471, filed on Jan. 9, 2018.

(51) Int. Cl. H04L 5/00; H04L 27/00; H04L 27/26

(52) U.S. Cl. CPC H04L 5/0053; H04L 27/2657; H04L 27/2678; H04L 27/0014

(57) ABSTRACT

The application relates to a network access node (100) for a wireless communication system (500). The network access node (100) generates a control message (502) comprising frequency information associated with a modulation frequency used by the network access node (100) for modulation of symbols for transmission to a client device (300). The network access node (100) further transmits the control message (502) to the client device (300). Furthermore, the application also relates to a client device (300), corresponding methods, and a computer program.

### CROSS-REFERENCE TO RELATED APPLICATIONS

This application is a continuation of International Application No. PCT/EP2018/050471, filed on Jan. 9, 2018, the disclosure of which is hereby incorporated by reference in its entirety.

### TECHNICAL FIELD

The application relates to a network access node and a client device. Furthermore, the application also relates to corresponding methods and a computer program.

### BACKGROUND

The 5G wireless communication system, also called new radio (NR), is currently being standardized. NR is targeting radio spectrum from below 1 GHz up to and above 60 GHz. To allow for such diverse radio environments not only different system bandwidths will be supported, but also different numerologies, such as different subcarrier-spacings (SCS).

When a user equipment (UE) is switched on in a wireless communication system an initial cell search is performed to find a cell to connect to. During the initial cell search the UE will search for synchronisation signal blocks (SSBs) by scanning potential carrier frequencies. In NR, the system bandwidth may be up to 100-200 MHz, compared to 20 MHz in Long Term Evolution (LTE). Furthermore, there may be multiple SSBs in the system bandwidth of a NR base station.

### SUMMARY

An objective of embodiments of the application is to provide a solution which mitigates or solves the drawbacks and problems of conventional solutions.

The above and further objectives are solved by the subject matter of the independent claims. Further advantageous embodiments of the present application can be found in the dependent claims.

According to a first aspect of the application, the above mentioned and other objectives are achieved with a network access node for a wireless communication system, the network access node being configured to

generate a control message comprising frequency information associated with a modulation frequency used by the network access node for modulation of symbols for transmission to a client device;

transmit the control message to the client device.

An advantage of the network access node according to the first aspect is that the client device receives knowledge of the modulation frequency used by the network access node. Hence, the client device can derive possible phase shifts between symbols introduced due to non-aligned client device centre frequency (used for demodulation) and network access node centre frequency (used for modulation) without a need for estimating the phase shifts. Thereby, improved decoding performance at the client device is achieved.

In an implementation form of a network access node according to the first aspect, the network access node is further configured to

modulate and up-convert a set of symbols to a carrier frequency f₀ being the modulation frequency.

An advantage with this implementation form is that the network access node transmits information using its own modulation frequency, thereby simplifying the implementation in the network access node.

In an implementation form of a network access node according to the first aspect, the frequency information indicates a frequency offset between a first centre frequency of a first signal transmission to the client device and the modulation frequency.

An advantage with this implementation form is that the frequency information can be signalled in a compact form, reducing the signalling overhead.

In an implementation form of a network access node according to the first aspect, the first signal transmission is at least one of:

a synchronization signal block transmission;

a primary broadcast channel transmission;

a CORESET of a remaining system information transmission; and

a CORESET of an other system information transmission.

An advantage with this implementation form is that client device knows the respective first centre frequency of the above listed types of transmissions and the client device can hence easily derive the modulation frequency from the received frequency offset information.

In an implementation form of a network access node according to the first aspect, the frequency information is indicated as a frequency offset parameter.

An advantage with this implementation form is that the frequency information can be signalled in a compact form, reducing the signalling overhead.

In an implementation form of a network access node according to the first aspect, the frequency offset parameter is given in a bit representation.

An advantage with this implementation form is that the frequency information can be signalled in a compact form, reducing the signalling overhead.

In an implementation form of a network access node according to the first aspect, the frequency information further indicates a system frequency range associated with the modulation frequency.

An advantage with this implementation form is that the frequency information can be signalled in a version easily interpreted by the client device.

In an implementation form of a network access node according to the first aspect, the frequency information further indicates at least one system frequency edge associated with the modulation frequency.

An advantage with this implementation form is that the frequency information can be signalled in a version easily interpreted by the client device.

In an implementation form of a network access node according to the first aspect, the frequency information is given as coding or masking of a reference signal associated with the control message.

An advantage with this implementation form is that coding or masking of a reference signal can be an efficient form of conveying the frequency information including simple hypothesis test correlations in the client device.

In an implementation form of a network access node according to the first aspect, the control message is at least one of: primary broadcast channel, remaining system information, other system information, and dedicated or group common radio resource control signalling.

An advantage with this implementation form is that the control message can be transmitted to the client device using existing signalling known to the client device.

According to a second aspect of the application, the above mentioned and other objectives are achieved with a client device for a wireless communication system, the client device being configured to

receive a control message from a network access node, wherein the control message comprises frequency information associated with a modulation frequency used by the network access node for modulation of symbols;

receive a second signal transmission from the network access node, wherein the second signal transmission comprises a set of modulation symbols and is received at a second centre frequency being frequency offset in relation to the modulation frequency;

determine a phase shift based on the frequency information of the control message and the second centre frequency;

phase adjust the set of modulation symbols based on the determined phase shift.

An advantage of the client device according to the second aspect is that the client device receives knowledge of the modulation frequency used by the network access node. Hence, the client device can derive possible phase shifts between symbols introduced due to non-aligned client device centre frequency and network access node centre frequency without a need for estimating the phase shifts. Thereby, the client device can phase adjust received modulation symbols and hence improved decoding performance is achieved.

In an implementation form of a client device according to the second aspect, the client device is further configured to

determine the phase shift based on the frequency information of the control message, the second centre frequency and cyclic prefix length of symbols of the set of modulation symbols.

According to a third aspect of the application, the above mentioned and other objectives are achieved with a method for a network access node, the method comprises

generating a control message comprising frequency information associated with a modulation frequency used by the network access node for modulation of symbols for transmission to a client device;

transmitting the control message to the client device.

The method according to the third aspect can be extended into implementation forms corresponding to the implementation forms of the network access node according to the first aspect. Hence, an implementation form of the method comprises the feature(s) of the corresponding implementation form of the network access node.

The advantages of the methods according to the third aspect are the same as those for the corresponding implementation forms of the network access node according to the first aspect.

According to a fourth aspect of the application, the above mentioned and other objectives are achieved with a method for a client device, the method comprises

receiving a control message from a network access node, wherein the control message comprises frequency information associated with a modulation frequency used by the network access node for modulation of symbols;

receiving a second signal transmission from the network access node, wherein the second signal transmission comprises a set of modulation symbols and is received at a second centre frequency being frequency offset in relation to the modulation frequency;

determining a phase shift based on the frequency information of the control message and the second centre frequency;

phase adjusting the set of modulation symbols based on the determined phase shift.

The method according to the fourth aspect can be extended into implementation forms corresponding to the implementation forms of the client device according to the second aspect. Hence, an implementation form of the method comprises the feature(s) of the corresponding implementation form of the client device.

The advantages of the methods according to the fourth aspect are the same as those for the corresponding implementation forms of the client device according to the second aspect.

The application also relates to a computer program, characterized in program code, which when run by at least one processor causes said at least one processor to execute any method according to embodiments of the present application. Further, the application also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the embodiments of the present application will be apparent from the following detailed description.

### BRIEF DESCRIPTION OF THE DRAWINGS

The appended drawings are intended to clarify and explain different embodiments of the present application, in which:

FIG. 1 shows a network access node according to an embodiment of the application;

FIG. 2 shows a method according to an embodiment of the application;

FIG. 3 shows a client device according to an embodiment of the application;

FIG. 4 shows a method according to an embodiment of the application;

FIG. 5 shows a wireless communication system according to an embodiment of the application.

### DETAILED DESCRIPTION

In NR the bandwidth of the gNB and the bandwidth of the UE may be separated from each other. Hence, the UE can connect and receive signals from the gNB even in cases where the bandwidth of the UE is smaller than the system bandwidth of the gNB. Furthermore, in order to optimize the system bandwidth, the UE can be configured to operate on a smaller bandwidth part (BWP) with a centre frequency which is not aligned with the gNB centre frequency.

According to the 5G/New Radio (NR) specification in TS 38.211v15.0.0, the time-continuous signal sₗ^{(p,μ)}(t) on antenna port p and subcarrier spacing configuration μ for orthogonal frequency division multiplexing (OFDM) symbol l in a subframe for any physical channel or physical signal except physical random access channel (PRACH) is defined by

$${s}_{l}^{( p , μ )} ( t ) = {\sum }_{k = 0}^{{N}_{RB}^{μ} {N}_{sc}^{RB} - 1} {a}_{k , l}^{( p , μ )} \cdot {e}^{j 2 π ( k + {k}_{0} - {N}_{RB}^{μ} {N}_{sc}^{RB} / 2 ) Δ f ( t - {N}_{CP , l}^{μ} {T}_{c} )}$$

where 0≤t<(Nᵤ^{μ}+N_{CP,l}^{μ})T_{c} and μ is the subcarrier spacing configuration. Furthermore, a_{k,l}^{(p,μ)} is the modulation symbol/on subcarrier k, N_{RB} is the number of physical resource blocks, and N_{SC} is the number of subcarriers per resource block (RB). Hence, the product N_{RB}*N_{SC} corresponds to the next generation eNode B (gNB) fast Fourier transform (FFT) size. Furthermore, Δf denotes the subcarrier spacing, T_{c} is the chip duration and the k₀ is an offset parameter. The function exp(j*x) in the above expression is the complex valued exponential function and hence sₗ^{(p,μ)} is the complex-valued baseband representation of the transmitted signal. Modulation and up-conversion to the carrier frequency f₀ of the complex-valued OFDM baseband signal for antenna port p and subcarrier spacing configuration μ is given by

Re{sₗ^{(p,μ)}(t)·e^{j2πf}^{₀}^{t}}.

The main difference of a synchronization signal transmission between NR and LTE is that in NR the central subcarrier of a SSB will not be aligned with the up-conversion carrier frequency f₀ for a gNB. The carrier frequency f₀ is the centre frequency of the FFT spanning the entire gNB system bandwidth (BW). Typically, the gNB system bandwidth is up to 20 MHz in LTE, while for NR the system bandwidth can be up to 100-200 MHz. Furthermore, in NR there can be multiple SSBs in the gNB system bandwidth. Moreover, the SSB in NR consists of the primary synchronization signal (PSS) and the secondary synchronization signal (SSS) as well as the physical broadcast channel (PBCH), which includes the master information block (MIB). In the MIB, information such that whether a cell is allowed for initial connection or not is found as well as information about the subframe number (SFN).

The eNB centre frequency in LTE is indirectly detected using the knowledge that the PSS, SSS and PBCH always are transmitted in the central 6 RBs centred around the carrier frequency. Therefore, once a UE have determined the PSS and SSS it has also determined the centre frequency of the eNB system bandwidth, and hence the centre frequency used in the receiver FFT processing.

The NR PBCH does not contain much information, instead there will be a pointer to where the remaining system information (RMSI) control resource set (CORESET) can be found. From this pointer, the UE gets information about a frequency range where the UE should monitor the CORESET, i.e. time-frequency resources in a control channel where indication of RMSI information is sent. In the RMSI further system information is given including random access channel (RACH) parameters for initial connection setup, and information and/or pointer to other system information (OSI).

For SSB symbols in NR, the baseband signal at a gNB transmitter can be written as:

$${s}_{l} ( t ) = {\sum }_{k = 0}^{{N}_{SSB} - 1} {a}_{k , l} \cdot {e}^{j 2 π ( k + M - {N}_{SSB} / 2 ) Δ f ( t - {N}_{CP , l} {T}_{c} )} \qquad ( Equation 1 )$$

where 0≤t<(Nᵤ+N_{CP,l})T_{c}, l=0, 1, 2 . . . a_{k,l} is the modulated symbol of a SSB, and wherein the SSB occupies only part of subcarriers in the system bandwidth, herein labelled as the FFT size of the SSB, i.e. N_{SSB}. The parameter M is the offset in subcarriers between the centre frequency of the gNB system bandwidth and the centre frequency of the SSB bandwidth.

The relationship between the frequency offset fₘ, the subcarrier offset M and the subcarrier spacing Δf is given as fₘ=M*Δf. The lower frequency of the SSB bandwidth starts at carrier frequency according to

$${f}_{M} - \frac{{N}_{SSB}}{2} Δ f = ( M - \frac{{N}_{SSB}}{2} ) Δ f .$$

According to the current status of NR specification, up-conversion to the carrier frequency f₀ of the SSB part of the baseband signal is given by

$$Re \{ {s}_{l} ( t ) {e}^{j 2 π {f}_{0} ( t + l ( {N}_{u} + {N}_{CP , l} ) {T}_{c} )} \} , \\ 0 \leq t < ( {N}_{u} + {N}_{CP , l} ) {T}_{c} , l = 0 , 1 , 2 … , . \qquad ( Equation 2 )$$

In initial cell search in NR, a UE will search for SSBs. In principle the UE will adapt its down-conversion frequency to a hypothetical down-conversion frequency fₓ and adapt its receiver bandwidth to cover the SSB signal, and down-convert the received signal and trying to detect the PSS and SSS. As long as the hypothetical down-conversion frequency fₓ is different from the frequency f₀+f_{M} the UE will not detect the SSB and will scan for further potential carrier frequencies.

Assuming an ideal channel, the received baseband signal after down-conversion by a receiver local oscillator at frequency f₀+f_{M}, i.e. the correct carrier frequency at the UE for detecting the SSB in an OFDM symbol without cyclic prefix (CP) length, can be expressed as

$$\begin{matrix}r ( t ) = {\sum }_{k = 0}^{{N}_{SSB} - 1} {a}_{k , l} {e}^{j 2 π ( k + M - {N}_{SSB} / 2 ) Δ f ( t - {N}_{CP , l} {T}_{c} )} \\ {e}^{- j 2 π M Δ f ( t + l ( {N}_{u} + {N}_{CP , l} ) {T}_{c} )} \\ = {\sum }_{k = 0}^{{N}_{SSB} - 1} {a}_{k , l} {e}^{j 2 π ( k - {N}_{SSB} / 2 ) Δ f ( t - {N}_{CP , l} {T}_{c} )} \\ {e}^{- j 2 π M Δ f ( {N}_{CP , l} {T}_{c} + l ( {N}_{u} + {N}_{CP , l} ) {T}_{c} )} \\ = {\sum }_{k = 0}^{{N}_{SSB} - 1} {a}_{k , l} {e}^{j 2 π ( k - {N}_{SSB} / 2 ) Δ f ( t - {N}_{CP , l} {T}_{c} )} \\ {e}^{- j 2 π M Δ f ( l + 1 ) {N}_{CP , l} {T}_{c}} ,\end{matrix} \\ 0 \leq t < ( {N}_{u} + {N}_{CP , l} ) {T}_{c} , l = 0 , 1 , 2 … , \qquad ( Equation 3 )$$

where f_{M}=MΔf is an unknown subcarrier offset between the carrier frequency at the receiver and the carrier frequency at the transmitter at the initial cell search phase for a UE. Hence, upon switching on a UE and performing an initial cell search in NR, the UE will be affected by an unknown phase shift between the symbols of the SSB, where the phase shift among other things is dependent on the length of the cyclic prefix as well as the frequency offset between the gNB centre (carrier) frequency and the SSB centre frequency as can be seen from the expression in Equation 3

ph(l)=e^{-j2πMΔf(l+1)N}^{_{CP,l}}^{T}^{_{c}}

where l is the symbol number. It can be noted that if M=0, i.e. no frequency offset between the SSB and the gNB offset, then ph(l)=1.

In fact, the above mention phase shift between consecutive OFDM symbols is not only present in the SSB case, but in all cases where the UE is configured to monitor a BWP, whose centre frequency is not aligned with the gNB centre frequency. The frequency offset may be estimated but the estimate will however be uncertain and will degrade the decoding performance especially in high throughput scenarios. Furthermore, due to the phase shift wrap around, the UE cannot estimate the exact gNB centre frequency, only a set of centre frequency candidates and hence optimized decoding performance cannot be achieved. Consequently, there is a need for a method and a device to mitigate this phase shift problem and thus optimize the decoding performance. The following disclosure presents a network access node, a client device and corresponding methods providing such a solution.

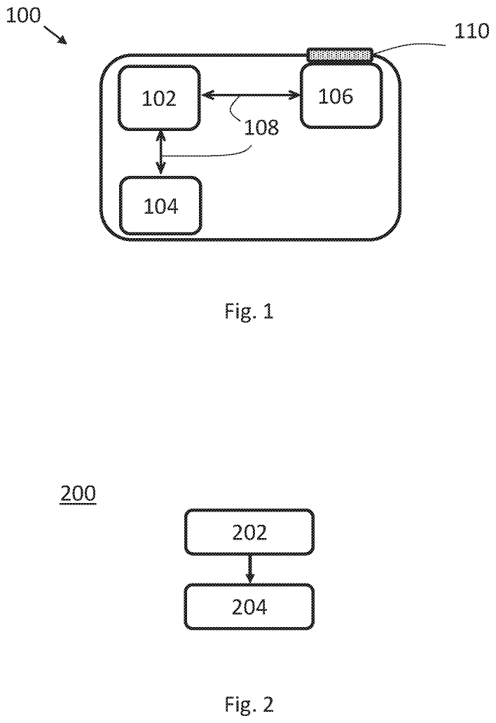

FIG. 1 shows a network access node 100 according to an embodiment of the application. In the embodiment shown in FIG. 1, the network access node 100 comprises at least one processor 102, an internal or external memory 104, and a transceiver 106. The processor 102 can be coupled to the memory 104 and the transceiver 106 by communication means 108 known in the art. The network access node 100 may further comprise a plurality of processors 102. The memory 104 may store program code that, when being executed, causes the processor(s) 102 of the network access node 100 to perform the functions and actions described herein. The network access node 100 further comprises an antenna or antenna array 110 coupled to the transceiver 106, which means that the network access node 100 is configured for wireless communications in a wireless communication system. That the network access node 100 is configured to perform certain actions should in this disclosure be understood to mean that the network access node 100 comprises suitable means, such as e.g. the processor 102 and the transceiver 106, configured to perform said actions. In embodiments, the processor 102 may e.g. be a baseband processor.

The network access node 100 herein is configured to generate a control message 502 comprising frequency information associated with a modulation frequency used by the network access node 100 for modulation of symbols for transmission to a client device 300. The network access node 100 is further configured to transmit the control message 502 to the client device 300.

FIG. 2 shows a flow chart of a corresponding method 200 which may be executed in a network access node 100, such as the one shown in FIG. 1. The method 200 comprises generating 202 a control message 502 comprising frequency information associated with a modulation frequency used by the network access node 100 for modulation of symbols for transmission to a client device 300. The method 200 further comprises transmitting 204 the control message 502 to the client device 300.

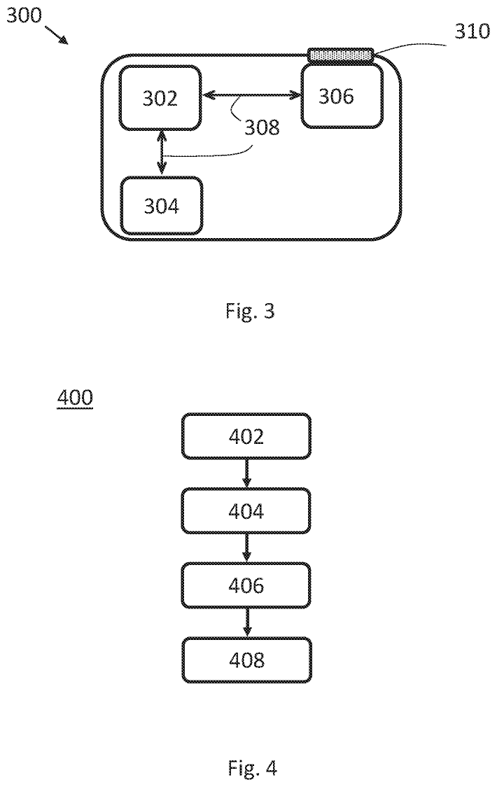

FIG. 3 shows a client device 300 according to an embodiment of the application. In the embodiment shown in FIG. 3, the client device 300 comprises at least one processor 302, an internal or external memory 304, and a transceiver 306. The processor 302 can be coupled to the memory 304 and the transceiver 306 by communication means 308 known in the art. The client device 300 may further comprise a plurality of processors 302. The memory 304 may store program code that, when being executed, causes the processor(s) 302 of the client device 300 to perform the functions and actions described herein. The client device 300 further comprises an antenna or antenna array 310 coupled to the transceiver 306, which means that the client device 300 is configured for wireless communications in a wireless communication system. That the client device 300 is configured to perform certain actions should in this disclosure be understood to mean that the client device 300 comprises suitable means, such as e.g. the processor 302 and the transceiver 306, configured to perform said actions.

The client device 300 herein is configured to receive a control message 502 from a network access node 100. The control message 502 comprises frequency information associated with a modulation frequency used by the network access node 100 for modulation of symbols. The client device 300 is further configured to receive a second signal transmission from the network access node 100. The second signal transmission comprises a set of modulation symbols and is received at a second centre frequency being frequency offset in relation to the modulation frequency. Furthermore, the client device 300 is configured to determine a phase shift based on the frequency information of the control message 502 and the second centre frequency; and phase adjust the set of modulation symbols based on the determined phase shift.

FIG. 4 shows a flow chart of a corresponding method 400 which may be executed in a client device 300, such as the one shown in FIG. 3. The method 400 comprises receiving 402 a control message 502 from a network access node 100. The control message 502 comprises frequency information associated with a modulation frequency used by the network access node 100 for modulation of symbols. The method 400 further comprises receiving 404 a second signal transmission from the network access node 100. The second signal transmission comprises a set of modulation symbols and is received at a second centre frequency being frequency offset in relation to the modulation frequency. Furthermore, the method 400 comprises determining 406 a phase shift based on the frequency information of the control message 502 and the second centre frequency; and phase adjusting 408 the set of modulation symbols based on the determined phase shift.

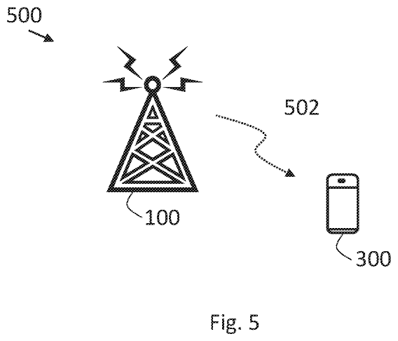

FIG. 5 shows a wireless communication system 500 according to an embodiment of the application. The wireless communication system 500 comprises a client device 300 and a network access node 100 configured to operate in the wireless communication system 500. For simplicity, the wireless communication system 500 shown in FIG. 5 only comprises one client device 300 and one network access node 100. However, the wireless communication system 500 may comprise any number of client devices 300 and any number of network access nodes 100 without deviating from the scope of the application.

In the wireless communication system 500, the network access node 100 may transmit a control message 502 to the client device 300, as previously described. The control message 502 comprises frequency information associated with the modulation frequency used by the network access node 100 for modulation of symbols for transmission to the client device 300. The client device 300 receives the control message 502 from the network access node 100 and may determine a phase shift based on the frequency information comprised in the control message 502. The determined phase shift may be used to phase adjust a set of modulation symbols received from the network access node 100. Hence, in further communication between the network access node 100 and the client device 300, there is no need for the network access node 100 to phase shift compensate symbols transmitted to the client device 300, since the client device 300 may perform phase adjustment of symbols received from the network access node 100 based on the determined phase shift. The symbols transmitted by the network access node 100 and received by the client device 300 may e.g. comprise a synchronization signal block, a CORESET of remaining system information, a CORESET of other system information, and a CORESET of a bandwidth part configured for the client device 300. However, the transmitted symbols may also comprise other types of symbols without deviating from the scope of the application.

In embodiments of the application, the modulation frequency used by the network access node 100 for modulation of symbols for transmission to the client device 300 may be the frequency used by the network access node 100 for performing the (inverse (I)) FFT and/or (I) discrete Fourier transform (DFT) processing of OFDM symbols. The (I)FFT and/or (I)DFT may be the corresponding Fourier transforms associated to the entire system bandwidth of the network access node 100, i.e. the total amount of transmitted physical resource blocks (PRBs). Thus, the network access node 100 may modulate and up-convert a set of symbols to a carrier frequency f₀ being the modulation frequency.

As previously described, the control message 502 comprises frequency information associated with the modulation frequency used by the network access node 100 for modulation of symbols for transmission to a client device 300. In embodiments of the application, the frequency information may indicate a frequency offset between a first centre frequency of a first signal transmission to the client device 300 and the modulation frequency. Based on this information, the client device 300 can with only little effort derive the phase shift between symbols transmitted around the first centre frequency (and correspondingly demodulated at the client device 300 with the first centre frequency) but modulated with the modulation frequency at the network access node 100. Hence, the client device 300 does not need to perform a phase shift estimation but can easily compute the phase shift.

The first signal transmission may be at least one of:

a synchronization signal block transmission;

a primary broadcast channel transmission;

a CORESET of a remaining system information transmission; and

a CORESET of an other system information transmission.

When the first signal transmission is any of the above listed types of transmissions, the client device 300 knows the respective first centre frequency of the first signal transmission. Hence, the client device can easily derive the modulation frequency from the received frequency information, when the frequency information indicates the frequency offset between the first centre frequency of the first signal transmission and the modulation frequency.

Furthermore, an edge frequency of the first signal transmission may in some cases be used such that the frequency offset represents an offset between a first edge frequency of the first signal transmission and the modulation frequency. The edge frequency may correspond to the first or last PRB or subcarrier included in the frequency range used for transmitting the first signal transmission. Whether the first centre frequency or the first edge frequency of the first signal transmission should be used may e.g. be determined based on a pre-defined rule or signalled in a control message. The control message is in this case generated by the network access node 100 and sent to the client device 300 using proper control signalling protocols. In case a pre-defined rule is used, the rule may be pre-defined in a wireless communication system standard.

When the frequency information indicates a frequency offset between a first centre frequency and the modulation frequency, the frequency information may be indicated as a frequency offset parameter. The frequency offset parameter may be given in a number of different ways. In an embodiment a bit representation is employed for representing the frequency offset parameter. The bit representation may be implemented using bit mapping, for instance a binary counter where an increase of a bit corresponds to a certain frequency hop, e.g. 15 kHz, 30 kHz, 100 kHz, etc. As mentioned, the bit representation may in embodiments indicate the frequency offset parameter, i.e. the frequency offset between the first centre frequency and the modulation frequency. However, a bit representation may also be used to indicate other types of frequency information, such as e.g. the absolute centre frequency in the frequency band the network access node 100 is operating in.

According to embodiments of the application, the frequency information may further indicate a system frequency range associated with the modulation frequency. Furthermore, the frequency information may indicate at least one system frequency edge associated with the modulation frequency. The system frequency edge may correspond to the first or last PRB or subcarrier included in the system frequency range. In cases where the frequency information indicates a system frequency range and/or at least one system frequency edge associated with the modulation frequency, information about the modulation frequency is implicitly signalled.

As described the frequency information associated with the modulation frequency may indicate different types of information such as a frequency offset, a system frequency range, and a system frequency edge. Independently of which type of information the frequency information indicates, the frequency information may be given as coding or masking of a reference signal associated with a control message 502. This means that instead of sending a bit map as a message, the corresponding reference signals are scrambled with a sequence corresponding to the frequency information. Hence, the client device 300 determines the scrambling by blind detection of scrambling sequence.

The control message 502 may be transmitted from the network access node 100 to the client device 300 in different way. For example, the control message 502 may be at least one of: primary broadcast channel, remaining system information, other system information, and dedicated or group common radio resource control (RRC) signalling. Dedicated or group common radio resource control signalling may e.g. be used when the client device 300 has performed a handover to a cell of the network access node 100.

To receive the control message 502 from the network access node 100 the client device 300 may adapt its monitoring centre frequency, i.e. the centre frequency used by the client device 300 prior to the IFF/FFT (IDFT/DFT) processing. In this case, the monitoring centre frequency is the same as the first centre frequency used by the network access node 100 to transmit the control message 502. In embodiments, the modulation symbols comprising the control message 502 may be pre-compensated for possible phase shift between the symbols by the network access node 100. The phase shift is dependent on the frequency offset between the modulation frequency and the first centre frequency. The client device 300 decodes the control message 502 and may from the decoded control message 502 extract the frequency information. Based on the frequency information the client device 300 may further determine the modulation frequency used by the network access node 100. In further processing of received signals from the network access node 100, the client device 300 may use the information about the modulation frequency used by the network access node 100 to phase compensate received modulation symbols prior to decoding. Hence, in further communication between the network access node 100 and the client device 300, there is no need for the network access node 100 to phase shift compensate transmitted symbols. Since the modulation frequency of network access node 100 is known by the client device 300, the client device 300 can derive the phase shift and perform phase shift compensation. The phase shift compensation can be performed due to possible phase shift between OFDM symbols originated by non-aligned modulation frequency used for network access node 100 FFT processing and client device 300 receive frequency used for client device 300 FFT processing. In other worlds, when the client device 300 receives a second signal transmission from the network access node 100, the client device 300 determines a phase shift based on the frequency information of the control message 502 and the second centre frequency. The second signal transmission may comprise a set of modulation symbols and may be received at a second centre frequency being frequency offset in relation to the modulation frequency. Based on the determined phase shift the client device 300 may phase adjust the set of modulation symbols comprised in the second signal transmission.

In embodiments, the client device 300 may determine the phase shift based on the frequency information of the control message 502, the second centre frequency and cyclic prefix length of symbols of the set of modulation symbols. In embodiments, the phase shift may be determined using the function ph(I) described in the beginning of the detailed description (see Equation 3).

The client device 300 herein, may be denoted as a user device, a User Equipment (UE), a mobile station, an internet of things (IoT) device, a sensor device, a wireless terminal and/or a mobile terminal, is enabled to communicate wirelessly in a wireless communication system, sometimes also referred to as a cellular radio system. The UEs may further be referred to as mobile telephones, cellular telephones, computer tablets or laptops with wireless capability. The UEs in the present context may be, for example, portable, pocket-storable, hand-held, computer-comprised, or vehicle-mounted mobile devices, enabled to communicate voice and/or data, via the radio access network, with another entity, such as another receiver or a server. The UE can be a Station (STA), which is any device that contains an IEEE 802.11-conformant Media Access Control (MAC) and Physical Layer (PHY) interface to the Wireless Medium (WM). The UE may also be configured for communication in 3GPP related LTE and LTE-Advanced, in WiMAX and its evolution, and in fifth generation wireless technologies, such as New Radio.

The network access node 100 herein may also be denoted as a radio network access node, an access network access node, an access point, or a base station, e.g. a Radio Base Station (RBS), which in some networks may be referred to as transmitter, “gNB”, “gNodeB”, “eNB”, “eNodeB”, “NodeB” or “B node”, depending on the technology and terminology used. The radio network access nodes may be of different classes such as e.g. macro eNodeB, home eNodeB or pico base station, based on transmission power and thereby also cell size. The radio network access node can be a Station (STA), which is any device that contains an IEEE 802.11-conformant Media Access Control (MAC) and Physical Layer (PHY) interface to the Wireless Medium (WM). The radio network access node may also be a base station corresponding to the fifth generation (5G) wireless systems.

Furthermore, any method according to embodiments of the application may be implemented in a computer program, having code means, which when run by processing means causes the processing means to execute the steps of the method. The computer program is included in a computer readable medium of a computer program product. The computer readable medium may comprise essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the client device 300 and the network access node 100 comprises the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the present solution.

Especially, the processor(s) of the client device 300 and the network access node 100 may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the application is not limited to the embodiments described above, but also relates to and incorporates all embodiments within the scope of the appended independent claims.

1. A network access node for a wireless communication system, comprising: a processor, a memory and a transceiver, and the network access node being configured to
generate a control message comprising frequency information associated with a modulation frequency used by the network access node for modulation of symbols for transmission to a client device;
transmit the control message to the client device.

2. The network access node according to claim 1, configured to
modulate and up-convert a set of symbols to a carrier frequency f₀ being the modulation frequency.

3. The network access node according to claim 1, wherein the frequency information indicates a frequency offset between a first centre frequency of a first signal transmission to the client device and the modulation frequency.

4. The network access node according to claim 3, wherein the first signal transmission is at least one of:
a synchronization signal block transmission;
a primary broadcast channel transmission;
a CORESET of a remaining system information transmission; and
a CORESET of an other system information transmission.

5. The network access node according to claim 3, wherein the frequency information is indicated as a frequency offset parameter.

6. The network access node according to claim 5, wherein the frequency offset parameter is given in a bit representation.

7. The network access node according to claim 1, wherein the frequency information further indicates a system frequency range associated with the modulation frequency.

8. The network access node according to claim 1, wherein the frequency information further indicates at least one system frequency edge associated with the modulation frequency.

9. The network access node according to claim 1, wherein the frequency information is given as coding or masking of a reference signal associated with the control message.

10. The network access node according to claim 1, wherein the control message is at least one of: primary broadcast channel, remaining system information, other system information, and dedicated or group common radio resource control signalling.

11. A client device for a wireless communication system, comprising: a processor, a memory and a transceiver, and the client device being configured to
receive a control message from a network access node, wherein the control message comprises frequency information associated with a modulation frequency used by the network access node for modulation of symbols;
receive a second signal transmission from the network access node, wherein the second signal transmission comprises a set of modulation symbols and is received at a second centre frequency being frequency offset in relation to the modulation frequency;
determine a phase shift based on the frequency information of the control message and the second centre frequency;
phase adjust the set of modulation symbols based on the determined phase shift.

12. The client device according to claim 11, configured to
determine the phase shift based on the frequency information of the control message, the second centre frequency and cyclic prefix length of symbols of the set of modulation symbols.

13. A method for a network access node, the method comprising
generating a control message comprising frequency information associated with a modulation frequency used by the network access node for modulation of symbols for transmission to a client device;
transmitting the control message to the client device.

14. The method according to claim 13, wherein the frequency information indicates a frequency offset between a first centre frequency of a first signal transmission to the client device and the modulation frequency.

15. The method according to claim 14, wherein the first signal transmission is at least one of:
a synchronization signal block transmission;
a primary broadcast channel transmission;
a CORESET of a remaining system information transmission; and
a CORESET of an other system information transmission.

16. The method according to claim 14, wherein the frequency information is indicated as a frequency offset parameter.

17. The method according to claim 15, wherein the frequency offset parameter is given in a bit representation.

18. The method according to claim 13, wherein the frequency information further indicates a system frequency range associated with the modulation frequency.

19. The method according to claim 13, wherein the frequency information further indicates at least one system frequency edge associated with the modulation frequency.

20. The method according to claim 13, wherein the frequency information is given as coding or masking of a reference signal associated with the control message.
